(19) United States
(12) Patent Application Publication
(10) Pub. No.: US 2026/0091380 A1
(43) Pub. Date: Apr. 2, 2026

(54) COMPOSITION INCLUDING LITHIATED BAYERITE AND METHOD OF MAKING

(71) Applicant: SAINT-GOBAIN CERAMICS & PLASTICS, INC., Worcester, MA (US)

(72) Inventors: Matthieu M. GRAS, Chateaurenard (FR); Wojciech L. Suchanek, Wyckoff, NJ (US); Marissa M. Reigel, Hudson, OH (US); Lucas Giardella, L'isle sur la sorgue (FR)

(21) Appl. No.: 19/344,289

(22) Filed: Sep. 29, 2025

Related U.S. Application Data
(60) Provisional application No. 63/700,328, filed on Sep. 27, 2024.
(60) Provisional application No. 63/714,560, filed on Oct. 31, 2024.

(51) Int. Cl. B01J 39/09; B01D 15/36; B01J 39/10; B01J 47/02

(52) U.S. Cl. CPC B01J 39/09; B01D 15/362; B01J 39/10; B01J 47/02

(57) ABSTRACT

A composition may include a crystalline phase including lithiated bayerite. The composition can have a Li/B Selectivity Factor of at least 4.2 and a Turbidity Factor of less than 1000 NTU. In an embodiment, the composition comprises a content of Li from 2 wt % to 5 wt %, a content of Cl from 10 wt % to 26 wt %, a content of Al from 15 wt % to 30 wt % of the composition, or a combination thereof. A product can include the composition of embodiments herein and be configured to extract lithium from a solution.

### CROSS-REFERENCE TO RELATED APPLICATION(S)

This application claims priority under 35 U.S.C. § 119(e) to U.S. Provisional Application No. 63/700,328, entitled “COMPOSITION INCLUDING LITHIATED BAYERITE AND METHOD OF MAKING,” by Matthieu M. GRAS et al., filed Sep. 27, 2024, and U.S. Provisional Application No. 63/714,560, entitled “COMPOSITION INCLUDING LITHIATED BAYERITE AND METHOD OF MAKING,” by Matthieu M. GRAS et al., filed Oct. 31, 2024, all of which are incorporated herein by reference in their entirety.

### FIELD OF THE DISCLOSURE

The following relates to a composition including lithiated bayerite and a method of forming the same.

### DESCRIPTION OF THE RELATED ART

Lithium adsorbents are used for extracting lithium from brines. Brines may include ions besides lithium that may also be adsorbed and end up in the final process stream, which hinders the process of lithium extraction and may require additional purification steps. The industry continues to demand improved process of lithium extraction.

### BRIEF DESCRIPTION OF THE DRAWINGS

The present disclosure may be better understood, and its numerous features and advantages made apparent to those skilled in the art by referencing the accompanying drawings.

FIG. 1 includes a flowchart illustrating a process for forming a composition including lithiated bayerite in accordance with an embodiment herein.

Skilled artisans appreciate that elements in the figures are illustrated for simplicity and clarity and have not necessarily been drawn to scale. For example, the dimensions of some of the elements in the FIGURES can be exaggerated relative to other elements to help improve understanding of embodiments of the invention. The use of the same reference symbols in different drawings indicates similar or identical items.

### DETAILED DESCRIPTION

The following description, in combination with the FIGURES, is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having,” or any other variation thereof are intended to cover a non-exclusive inclusion. For example, a process, method, article, or apparatus that comprises a list of features is not necessarily limited only to those features but can include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one, and the singular also includes the plural, or vice versa, unless it is clear that it is meant otherwise.

Unless otherwise defined, all technical and scientific terms used herein have the same meaning as commonly understood by one of ordinary skill in the art to which this invention belongs. The materials, methods, and examples are illustrative only and not intended to be limiting.

Embodiments herein relate to a composition including a crystalline phase including lithiated bayerite. The composition may be suitable for applications of lithium extraction from solutions of salts. The composition may have improved lithium adsorption, improved mechanical strength, improved moldability, or any combination thereof compared to conventional lithium adsorbents that may include lithium bayerite. Improved lithium adsorption may include significantly reduced adsorption of ions other than lithium when used in lithium extraction from a solution that may include a mixture of salts. In a particular embodiment, the composition may have significantly reduced adsorption of boron. Embodiments further relate to a method of forming the composition. The method may include forming a mixture of suitable starting materials and carefully controlling the pH of the mixture to facilitate formation of the composition with improved lithium selectivity over another ion, mechanical strength, moldability, or any combination thereof. As used herein, lithiated bayerite is intended to refer to compounds having a formula of xLiCl·2Al(OH)₃·nH₂O, as indicated in the ICDD PDF 00-031-0700, and extended to include instances when the molar ratio of Li/Al of those compounds become greater or smaller than 0.5.

In an embodiment, the composition may include a crystalline phase including lithiated bayerite and a combined content of aluminum hydroxide (Al(OH)₃) and boehmite (γ-AlO(OH)) content of 10 wt % or less for the total weight of the composition. For example, the combined content of aluminum hydroxide and boehmite may be at most 8 wt % or at most 5 wt %. In another example, the composition may be essentially free of aluminum hydroxide, boehmite, or both. In a particular example, the composition may be essentially free of aluminum hydroxide and boehmite. As used herein, when a composition is essentially free of a component, the content of the component may be at most 1 wt % or less.

The combined content of aluminum hydroxide and boehmite content may be calculated according to formula (1), T=100*(A_{HA}+A_{BO})/(A_{HA}+A_{BO}+A_{BL}), wherein A_{HA} is the sum of the areas of the aluminum hydroxide phases, measured on an X-ray diffraction diagram of said product, for example obtained from an X′Pert diffractometer type apparatus from Panalytical, provided with a copper DX tube, without deconvolution processing, after eliminating the Kα2 line. The area of an aluminum hydroxide phase is that of its diffraction peak lying in an angular range 20 substantially equal to 18.3°; A_{BO} is the area of the boehmite diffraction peak lying in an angular range 20 substantially equal to 14°, measured on the same diagram, without deconvolution processing, after having eliminated the Kα2 line; A_{BL} is the area of the diffraction peak of plane (003) of lithiated bayerite lying in an angular range 20 substantially equal to 11.3°, measured on the same diagram, without deconvolution processing, after having eliminated the line Kα2.

In another embodiment, the composition may include lithiated bayerite crystallites having a particular average size. For example, the average crystallite size of lithiated bayerite may be at 10 nm, at least 15 nm, at least 18 nm, at least 20 nm, or at least 23 nm. In another example, the average crystallite size may be at most 25 nm, at most 22 nm, at most 19 nm, at most 16 nm, or at most 13 nm. In a further example, the average size of lithiated bayerite crystallites may be in a range including any of the minimum and maximum values noted herein. As used herein, for analyzing crystalline phases of the composition and determining the average size of lithiated bayerite crystallites and the combined content of aluminum hydroxide and boehmite, the composition may be prepared by exposure to air for 170 hours at 25° C. and atmospheric pressure and then analyzed. The average crystallite size may be determined utilizing X-ray diffraction analysis of a sample of the prepared composition and Scherrer equation.

In an embodiment, the composition may include a crystalline phase including boehmite and/or aluminum hydroxide. In another embodiment, the composition may include crystalline aluminum hydroxide selected from gibbsite, bayerite, doyleite, nordstrandite and any combinations thereof. In another embodiment, the composition may include crystalline lithiated bayerite and crystalline aluminum hydroxide selected from gibbsite, bayerite, doyleite, nordstrandite, and any combination thereof. In another embodiment, the composition may be essentially free of crystalline boehmite. In still another embodiment, the composition may be essentially free of crystalline aluminum hydroxide. In a further embodiment, a majority or essentially all of the crystalline phase of the composition may include lithiated bayerite crystallites. In a particular embodiment, the composition may include a single crystalline phase including lithiated bayerite.

In an embodiment, the composition may include water. In a further embodiment, the composition may include a particular content of water that may facilitate improved property and/or performance of the composition. In an example, the composition may include at most 85 wt %, at most 80 wt %, at most 75 wt %, at most 65 wt %, or at most 55 wt % of water for the total weight of the composition. In another example, the content of water may be at least 5 wt %, at least 10 wt %, at least 15 wt %, at least 25 wt %, at least 35 wt %, at least 40 wt %, at least 45 wt %, at least 50 wt %, or at least 55 wt % for the total weight of the composition. In a further example, the content of water may be in a range including any of the minimum and maximum percentages noted herein. For instance, the content of water may be in a range including at least 15 wt % and at most 85 wt % or in a range including at least 35 wt % and at most 75 wt % or in a range including at least 45 wt % and at most 65 wt %. The water content as used herein is the loss of mass after drying at 200° C. for 16 hours in air at atmospheric pressure, relative to the original weight of the composition prior to drying.

In a further embodiment, the composition may include elements Li, Cl, Al, O and H. In a further embodiment, the composition may include a particular content of Li that may facilitate improved property and/or performance of the composition. As used herein, the content of an element in the composition can be determined by utilizing inductively coupled plasma spectrometry to analyze the dried composition. The term “dried composition” is intended to refer to the composition obtained after drying in air at 200° C. for 16 hours (at atmospheric pressure). Drying can be carried out using a conventional technique, such as drying in an oven. The term “dry weight of the composition” is intended to refer to the total weight of the dried composition. In an example, the content of Li may be at least 2 wt % or greater than 2 wt % for the dry weight of the composition, such as at least 2.5 wt %, at least 3 wt %, at least 3.5 wt %, at least 4 wt %, or at least 4.5 wt % for the dry weight of the composition. In a further example, the content of Li may be at most 5 wt % or less than 5 wt % for the dry weight of the composition, such as at most 4.7 wt %, at most 4.5 wt %, at most 4.1 wt %, at most 3.8 wt %, at most 3.4 wt % or at most 3.1 wt % for the dry weight of the composition. In a further example, the content of Li may be in a range including any of the minimum and maximum percentages noted herein. For instance, the content of Li may be in a range including at least 2 wt % and at most 5 wt % or in a range including greater than 2 wt % and less than 5 wt %.

In an embodiment, the composition may include a particular content of Cl that may facilitate improved property and/or performance of the composition. In an example, the content of Cl may be at least 10 wt % or greater than 10 wt % for the dry weight of the composition, such as at least 11 wt %, at least 13 wt %, at least 15 wt %, at least 18 wt %, at least 20 wt %, at least 23 wt %, or at least 25 wt % for the dry weight of the composition. In a further example, the content of Cl may be at most 26 wt % or less than 26 wt % for the dry weight of the composition, such as at most 25 wt %, at most 23 wt %, at most 20 wt %, at most 18 wt %, at most 15 wt %, at most 13 wt % or at most 11 wt % for the dry weight of the composition. In a further example, the content of Cl may be in a range including any of the minimum and maximum percentages noted herein. For instance, the content of Cl may be in a range including at least 10 wt % and at most 26 wt % or in a range including greater than 10 wt % and less than 26 wt %.

In an embodiment, the composition may include a particular content of Al that may facilitate improved property and/or performance of the composition. In an example, the content of Al may be at least 15 wt % or greater than 15 wt % for the dry weight of the composition, such as at least 16 wt %, at least 18 wt %, at least 20 wt %, at least 23 wt %, at least 25 wt %, at least 27 wt %, or at least 29 wt % for the dry weight of the composition. In a further example, the content of Al may be at most 30 wt % or less than 30 wt % for the dry weight of the composition, such as at most 29 wt %, at most 27 wt %, at most 25 wt %, at most 23 wt %, at most 21 wt %, at most 18 wt % or at most 16 wt % for the dry weight of the composition. In a further example, the content of Al may be in a range including any of the minimum and maximum percentages noted herein. For instance, the content of Al may be in a range including at least 15 wt % and at most 30 wt % or in a range including greater than 15 wt % and less than 30 wt %.

In an embodiment, the composition may include elements O and H. In another embodiment, the composition may include an element other than Li, Cl, Al, O and H, wherein a total content of such element may be less than 3 wt %, or at most 2 wt %, or at most or less than 1 wt % of the dry weight of the composition. It can be appreciated that an element other than Li, Cl, Al, O and H may be from an unavoidable impurity that may come from a starting material or included during the process of forming or preparing the composition. Exemplary impurities may include sodium chloride, sodium hydroxide, ammonium hydroxide, aluminum chloride, or any combination thereof. In at least one embodiment, the composition may include a total content of impurities of at most 3 wt %, at most 2 wt %, at most 1 wt %, or less than 1 wt % of the composition.

In an embodiment, the composition may include a particular weight content ratio of Li/Al that may facilitate improved performance and/or properties of the composition. For example, the weight content ratio of Li/Al may be at least 0.07, such as at least 0.10, at least 0.13, at least 0.15, or greater than 0.15. In another example, the ratio of Li/Al may be at most 0.33, such as at most 0.30, at most 0.28, at most 0.25, or below 0.25. Moreover, the ratio of Li/Al may be in a range including any of the minimum and maximum values noted herein.

In an embodiment, the composition may include a particular weight content ratio of Li/Cl that may facilitate improved performance and/or properties of the composition. For example, the weight content ratio of Li/Cl may be at least 0.08, such as at least 0.10, at least 0.11, at least 0.12, at least 0.13, at least 0.15, or greater than 0.15. In another example, the ratio of Li/Cl may be at most 0.4, such as at most 0.37, at most 0.35, at most 0.32, at most 0.30, at most 0.28, at most 0.25, or less than 0.25. Moreover, the ratio of Li/Cl may be in a range including any of the minimum and maximum values noted herein.

In a further embodiment, the composition may include a binder. In a particular example, the binder may include polysaccharide, and more particularly, the polysaccharide may include a group that may be capable of forming an ionic bond with a gelling agent to form a gelled polysaccharide. A particular example of a suitable polysaccharide may include alginates. As sued herein, gelled polysaccharide may be formed via the association of chains of the polysaccharide under the action of a gelling agent. By way of example, alginate has the formula (C₆H₇O₆⁻)ₙ. Alginate has a polysaccharide chain containing carboxyl groups COO⁻. Ca²⁺ (a gelling agent) may react with two of the carboxyl groups COO⁻, which may result in the polymerization of the alginate chains and the binding of the molecules to each other and formation of a gel.

In an embodiment, at least 80 wt %, at least 85 wt %, at least 90 wt %, at least 95 wt %, or at least 99 wt % of the composition may include water, lithiated bayerite, aluminum hydroxide and/or boehmite, LiCl, and a binder. In a particular example, the composition may include a gelled binder, such as gelled polysaccharide. In another embodiment, at least 80 wt %, at least 85 wt %, at least 90 wt %, at least 95 wt %, or at least 99 wt % of the composition may include water, lithiated bayerite, aluminum hydroxide, LiCl, and a binder, such as a gelled polysaccharide. In another embodiment, at least 80 wt %, at least 85 wt %, at least 90 wt %, at least 95 wt %, or at least 99 wt % of the composition may include water, lithiated bayerite crystallites, LiCl, and a binder, such as a gelled polysaccharide.

In a particular embodiment, the composition may have a Li/B Selectivity Factor of at least 4.2, at least 4.7, at least 5.1, at least 5.5, at least 5.6, at least 6.1, at least 6.5, at least 6.9, at least 7.5, at least 7.9, at least 8.4, at least 8.9, at least 9.3, at least 9.7, at least 10.3, at least 10.6, at least 11.2, at least 11.6, at least 12.2, at least 12.6, at least 13.2, at least 13.8, or at least 14.2, at least 14.6, at least 15, or at least 15.5, at least 16. Alternatively or additionally, the composition may include the Li/B Selectivity Factor of at most 22.5, at most 21.5, at most 21.0, at most 19.6, at most 19.2, at most 18.5, at most 18.1, at most 17.6, at most 17.1, at most 17.0, at most 16.5, or at most 16. Moreover, the Li/B Selectivity Factor may be in a range including any of the minimum and maximum values noted herein. The Li/B Selectivity Factor may be determined according to the test described in Example 1.

In a particular embodiment, the composition may have a Turbidity Factor of less than 1000 NTU, such as less than 980 NTU, at most 900 NTU, at most 850 NTU, at most 800 NTU, at most 700 NTU, at most 600 NTU, at most 500 NTU, at most 400 NTU, at most 300 NTU, at most 210 NTU, at most 180 NTU, at most 160 NTU, at most 130 NTU, at most 110 NTU, at most 90 NTU, at most 80 NTU, or at most 75 NTU. Alternatively or additionally, the composition may include a Turbidity Factor of at least 1 NTU, at least 5 NTU, at least 10 NTU, at least 15 NTU, at least 25 NTU, at least 40 NTU, at least 50 NTU, at least 60 NTU, at least 65 NTU, at least 68 NTU, at least 72 NTU, at least 77 NTU, at least 80 NTU, at least 90 NTU, at least 100 NTU, at least 130 NTU, at least 180 NTU, at least 220 NTU, at least 330 NTU, at least 400 NTU, at least 450 NTU, at least 500 NTU, at least 560 NTU, at least 620 NTU, or at least 650 NTU. Moreover, the Turbidity Factor may be in a range including any of the minimum and maximum values noted herein. The Turbidity Factor may be determined according to the test described in Example 1.

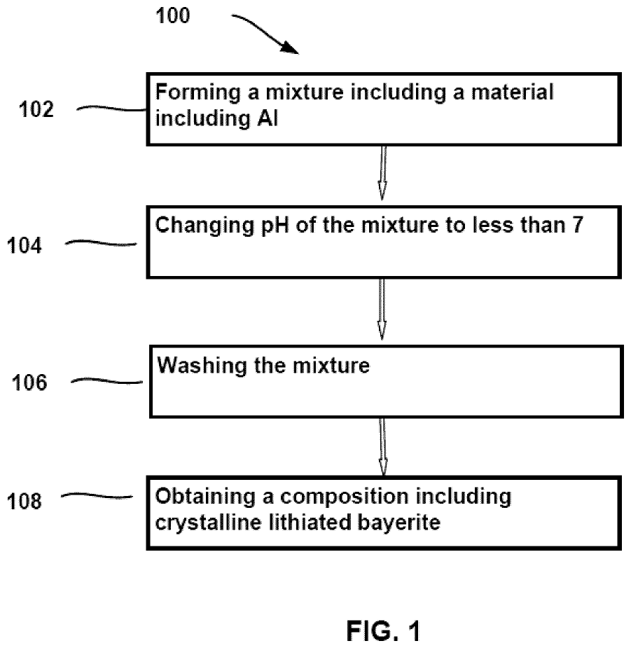

FIG. 1 includes a flowchart including steps of the method 100 for forming the composition of embodiments herein. The method 100 may include forming a mixture including a material including aluminum (Al) at block 102. In an embodiment, the material including aluminum may include a source of aluminum. In another embodiment, the method 100 may include preparing an aqueous suspension of a source of aluminum. In a particular example, the source of aluminum may be a single source of aluminum. An exemplary source of aluminum may include boehmite, aluminum hydroxide, or a combination thereof. In a particular example, aluminum hydroxide may be utilized as the source. A particular example of aluminum hydroxide may include gibbsite. In a more particular example, forming the mixture may include preparing an aqueous suspension including gibbsite.

In a further embodiment, the aluminum source may have a particular median particle size that may facilitate improved formation of the composition. In an example, the aluminum source may have the median particle size of at most 3 μm, at most 2 μm, at most 1 μm, at most 0.7 μm, or at most 0.5 μm. In another example, the median particle size of the aluminum source may be at least 0.05 μm, at least 0.08 μm, at least 0.1 μm, at least 0.3 μm, or at least 0.5 μm. Moreover, the median particle size of the aluminum source may be in a range including any of the minimum and maximum values noted herein. In an embodiment, the method 100 may include reducing the median particle size of the aluminum source to any of the median particle sizes described in embodiments herein when the aluminum source has the median particle size greater than 3 μm.

In an embodiment, the method 100 may include grinding the aqueous suspension to reduce the median particle size of the aluminum source to any of the median particle sizes described in embodiments herein. For example, gibbsite having the median particle size greater than 3 μm may be ground to reduce the median particle size. Grinding may be carried out according to any technique known to a person skilled in the art, such as by wet grinding. In another embodiment, preparation of the aqueous suspension of the aluminum source and grinding the aqueous suspension may be carried out simultaneously. In still another embodiment, reducing the median particle size of the aluminum source may be performed prior to forming the aqueous suspension. In a further embodiment, the suspension may be kept at a temperature of lower than 50° C., particularly when grinding is performed. In a further example, the suspension may be maintained at a temperature greater than 15° C., or at least 20° C. Moreover, the temperature of the suspension may be kept in a temperature in a range greater than 15° C. and below 50° C. or in a range from 20° C. to below 50° C.

In an embodiment, forming the mixture may include adding a base to the aqueous suspension. In another embodiment, the method 100 may include increasing the pH of the aqueous suspension by adding a base, such that a particular molar ratio between the OH supplied by the base and the Al present in the mixture may be achieved. In an example, the molar ratio may be greater than 0.20 or at least 0.25 or at least 0.40 or at least 0.50. In another example, the molar ratio may be less than 10 or at most 9 or at most 8 or at most 7 or at most 6 or at most 5 or at most 4 or at most 3 or at most 2 or at most 1.5. Moreover, the molar ratio between the OH supplied by the base and the Al present in the mixture may be in a range including any of the minimum and maximum values noted herein, such as in a range greater than 0.20 and less than 10 or in a range including at least 0.25 and at most 9.

In an embodiment, the pH of the mixture after addition of the base may be at least 9 or at least 10. Additionally or alternatively, the pH may be at most 13 or at most 12 after the addition of a base. Moreover, after addition of a base, the pH of the mixture may be in a range including any of minimum and maximum values noted herein. In an embodiment, the mixture may be stirred when a base is added to facilitate formation of uniform mixture. In a particular embodiment, the base may not contain aluminum element. In another embodiment, the base may be chosen from NaOH, LiOH, NH₄OH, KOH, Ca(OH)₂, RbOH, CsOH, Sr(OH)₂, Ba(OH)₂, Mg(OH)₂, and mixtures thereof. In a particular example, the base may be chosen from NaOH, LiOH, NH₄OH, and mixtures thereof. In a more particular example, the base may be LiOH.

In a further embodiment, stirring of the mixture may continue after introduction of the base and the temperature of the mixture may be kept below 50° cand greater than 15° C., such as at least 20° C., or at least 25° C. In a further embodiment, the stirring time after the addition of a base may be greater than 5 minutes, greater than 10 minutes, or greater than 15 minutes, and less than 5 hours. In another embodiment, preparation of the aqueous suspension of an aluminum source and the addition of a base may be performed simultaneously.

In a further embodiment, the method 100 may include adding a chloride salt to the mixture. In a further embodiment, the addition of a chloride salt may be controlled such that the molar ratio of Cl supplied by the chlorine salt to Al present in the mixture may be greater than 0.25, such as at least 0.40, at least 0.5, at least 0.60, or at least 1.0. Alternatively or additionally, the molar ratio between the Cl supplied by the chlorine salt to the Al present in the mixture may be less than 10, such as at most 9, at most 8, at most 7, at most 6, at most 5, at most 4, at most 3, at most 2, or at most 1.5. Moreover, the molar ratio between the Cl supplied by the chlorine salt to the Al present in the mixture may be in a range including any of the minimum and maximum values noted herein.

In a further embodiment, stirring of the mixture may continue after the addition of the chlorine salt and the mixture may be kept at a temperature below 50° C. and greater than 15° C., such as at least 20° C., or at least 25° C. In a further embodiment, the stirring time after the addition of the chlorine salt may be greater than 5 minutes, such as greater than 10 minutes, or greater than 15 minutes, and less than 48 hours.

In an embodiment, the chloride salt may not contain aluminum element. In another embodiment, the chloride salt may be chosen from LiCl, NaCl, KCl, CaCl₂, NH₄Cl, MgCl₂ and mixtures thereof. In a particular example, the chloride salt may be chosen from LiCl, NaCl, KCl, CaCl₂, or any combinations thereof. In a more particular example, the chlorine salt may be LiCl.

In another embodiment, preparation of the aqueous suspension of an aluminum source, the addition of a base, and/or the addition of a chloride salt may be performed simultaneously. For example, adding a base and adding a chloride salt may be performed simultaneously. In still another embodiment, preparation of the aqueous suspension of an aluminum source, the addition of a base, and the addition of a chloride salt may be performed simultaneously.

In a further embodiment, the base, the chloride salt, and their respective amounts may be carefully chosen so that the quantity of lithium in the mixture may provide the molar ratio of Li/Al of at least 1, at least 1.1, or at least 1.2. Alternatively or additionally, the molar ratio Li/Al may be at most 4, such as at most 3.5, at most 3, or at most 2. Moreover the molar ratio of Li/Al may be in a range including nay of the minimum and maximum values noted herein.

In a particular embodiment, the method 100 may include dissociating agglomerated particles in the mixture. Agglomerated particles may include agglomerated aluminum source particles, such as agglomerated aluminum hydroxide particles. In a particular example, a high shear mixer may be utilized to deagglomerate particles. In an exemplary implementation, an inline dispersing machine IKA Turrax UTL 2000 may be used. In a further embodiment, dissociation of agglomerated particles may be performed for greater than 1 minute, such as at least 3 minutes, at least 6 minutes, or at least 10 minutes. In another embodiment, the time for performing deagglomeration may be at most 35 min, such as at most 30 min, at most 25 min, at most 20 min, or at most 15 min. Moreover, the time for performing deagglomeration may be in a range including any of the minimum and maximum values noted in embodiments herein.

In an embodiment, the method 100 may further include raising the temperature of the mixture to at least 50° C. and at most 60° C. after deagglomeration is performed. Stirring of the mixture may be maintained when the temperature is increased. The time when the mixture is at a temperature of at least 50° C. may be referred to as t₁. In an example, t₁ may be at least 15 minutes, at least 20 minutes, or at least 25 minutes. In another example, t₁ may be at most 15 hours, at most 10 hours, at most 5 hours, at most 1 hour, at most 40 minutes, at most 30 minutes, or at most 20 minutes. Moreover, t₁ may be in a range including any of the minimum and maximum times noted herein.

In a further embodiment, the method 100 may include maintaining the mixture at a substantially constant temperature of at least 50° C. and at most 60° C. for a time period t₂. The mixture may be stirred during the time period t₂. In an example, t₂ may be at least 40 minutes, such as at least 45 minutes, or at least 60 minutes. Additionally or alternatively, t₂ may be at most 10 hours, at most 7 hours, or at most 3 hours, at most 2 hours, or at most 1 hour. Moreover, t₂ may be in a range including any of the minimum and maximum times noted herein.

The method may continue to block 104, changing the pH of the mixture to less than 7. In an embodiment, the method 100 may include adding an acid to adjust the pH of the mixture. In a particular embodiment, the pH may be adjusted to less than 6.5, such as at most 6.0, at most 5.5, at most 5.0, at most 4.5, at most 4.0, at most 3.5, or at most 3.0. In a more particular example, the pH may be adjusted to below 3.0, at most 2.5, at most 2.0, at most 1.5, or at most 1.0. Alternatively or additionally, the pH of the mixture may be adjusted to greater than 0, such as at least 0.2, at least 0.5, at least 0.7, at least 0.9, or at least 1.0. Moreover, the pH of the mixture may be adjusted to have a value including any of the minimum and maximum values noted herein. In another embodiment, the pH of the mixture may be changed to a value in a range from greater than 0 to up to 6.0, in a range from 1.0 to 6.0, or in a range from 1.0 to below 3.0. In a further example, the addition of an acid may be facilitated by stirring the mixture, and the temperature of the mixture may be maintained at no greater than 60°. In a particular example, the temperature of the mixture may be maintained substantially constant. The time t₃ may indicate the time that the temperature of the mixture is at least 50° C. after addition of acid. In an example, t₃ may be at least 5 minutes, or at least 10 minutes. In another example, t₃ may be at most 60 minutes or at most 40 minutes. Moreover, the time period t₃ may be in a range including any of the minimum and maximum values noted herein.

In an embodiment, the acid and the amount thereof may be carefully chosen so that a particular Cl/Al molar ratio in the mixture may be obtained. In an example, the Cl/Al molar ratio may be at least 1 or greater than 1. In another example, the Cl/Al molar ratio may be less than 3 or at most 2. Moreover, the Cl/Al molar ratio may be in a range including any of the minimum and maximum values noted herein. In particular instances, the amount of Cl necessary to obtain the Cl/Al molar ratio of at least 1 may be at least partially provided by the acid. In an embodiment, more than one acid may be added to the mixture. In a further embodiment, at least one of the acids may include Cl. An exemplary acid may include HCl, H₂SO₄, HNO₃, HI, HBr, HClO₄, HClO₃, HMnO₄, H₂MnO₄, or any combinations thereof. In a particular example, the acid may be selected from HCl, HNO₃, HBr, HClO₄, HClO₃, or any combinations thereof. In a more particular example, the acid may include HCl. In an even more particular example, the acid may be HCl.

In a further embodiment, the method 100 may include filtration of the mixture to obtain a paste. In a particular embodiment, filtration may be performed after the pH is adjusted by the addition of an acid. The mixture may be maintained at a temperature of at most 60° C. during filtration and particularly, the temperature of the mixture may be kept substantially constant. The time t₄ may be in reference to the time the mixture is at least 50° C. when filtration is performed. In an example, the time t₄ may be at most 15 minutes, at most 10 minutes, or at most 5 minutes. In another example, the time t₄ may be at least 1 minute, at least 3 minutes, or at least 5 minutes. Moreover, the time t may be in a range including any of the minimum and maximum values noted herein. In an embodiment, the temperature of the mixture may be lowered to below 50° C. and at least 15° C. before the start of filtration, which may help avoid overheating the mixture during filtration. Any known filtration technique can be used during this step, in particular a filter press, a centrifuge, a band filter, a drum filter, or any combination thereof.

The method 100 may continue to block 106, washing the mixture. In an embodiment, washing may be performed after filtration. In a particular embodiment, washing may be performed after changing the pH by adding an acid. In a particular embodiment, the method 100 may include washing the paste with an aqueous phase. An exemplary aqueous phase may include water or an aqueous solution having a total ion content of less than 2 g/L. In a particular exemplary implementation, pure water at room temperature (i.e., 20-25° C.) may be used to wash the paste. In an embodiment, washing may be conducted for a particular time t₅. In an example, t₅ may be at least 1 minute, at least 2 minutes, at least 3 minutes, at least 4 minutes, or at least 5 minutes. In another example, t₅ may be at most 25 minutes, such as at most 20 minutes, at most 15 minutes, or at most 10 minutes. Moreover, t₅ may be in a range including any of the minimum and maximum values noted herein. In another embodiment, washing may include partially removing lithium and chloride from the paste, which may facilitate improved integrity, strength, structure, and/or performance of the composition. It is noted the washing efficiency may be higher when water is used compared to an aqueous solution having a total ion content of less than 2 g/L. In a particular implementation, the paste may be washed in a Watermark FP470G32L filter press by water closed loop recirculation. In another embodiment, washing may be performed prior to filtration.

In an embodiment, washing may include utilizing a particular content of an aqueous phase. In a further embodiment, washing may include utilizing a particular weight ratio of an aqueous phase to the paste. In a particular embodiment, the weight ratio of an aqueous phase to the paste may be less than 1:1, such as at most 0.9:1, at most 0.8:1, at most 0.7:1, or at least 0.6:1. Alternatively or additionally, the weight ratio of the aqueous phase to the paste may be at least 0.4:1, or greater than 0.4:1, such as at least 0.5:1, at least 0.6:1, at least 0.7:1, or at least 0.8:1. In a further example, a weight ratio of an aqueous phase to the paste may be in a range including any of the minimum and maximum values noted herein. In still another example, a weight ratio of water to the paste may include any of the ratios noted in embodiments herein.

In an embodiment, at least a portion of the lithium chloride obtained from the filtration and/or washing processes may be collected and reused. In a further embodiment, the method 100 may include using recovered lithium chloride as at least part of a chloride salt.

In a particular embodiment, t₁+t₂+t₃+t₄+t₅=t₆, wherein t₆ may be the time during which the mixture may be exposed to a temperature of at least 50° C. and at most 60° C. In a particular embodiment, the time period t₆ may be at least 45 minutes, at least 50 minutes, at least 55 minutes, or at least 1 hour. Alternatively or additionally, the time period t₆ may be less than 15 hours.

In an embodiment, after filtration and washing, the mixture, which may be in the form of a paste, may have any of the features described with respect to the composition of embodiments herein. For example, the mixture may include a crystalline phase including lithiated bayerite. In another embodiment, after filtration and washing is completed, the mixture may be shaped. Shaping may be performed such that the shaped mixture may suit the need of an application. In an exemplary implementation, the mixture may be shaped so that it may be placed into a column for applications in ion extractions. It is to be appreciated that shaping can be performed for the mixture to have any shapes that can suit the needs of applications.

In a further embodiment, the mixture may be subject to further processing to form the composition described in embodiments herein. In an embodiment, the method 100 may include mixing a binder into the mixture. The binder may facilitate improved shaping of the mixture. An exemplary binder may include an organic material, such as a polymer. In another embodiment, shaping the mixture may include preparing a feedstock including the composition of the washed paste and a binder and shaping the feedstock. The shaping can be carried out according to any technique known to the person skilled in the art, for example extrusion, granulation, pressing, casting, atomization, screen printing, tape casting or drip casting, or by stamping, lamination, coating, granulation, or any combination thereof. In a particular example, shaping may be performed via screen printing.

In an embodiment, the feedstock may include a particular content of a binder that may facilitate improved formation of the composition. As disclosed herein, the content of the binder is relative to the weight of the dried feedstock. The feedstock may be dried in hot air in the temperature from 50° C. to 200° C. In a particular example, the feedstock may be dried in vacuum at a temperature from 50° C. to 100° C. Moisture content analysis can be performed at 200° C. to determine whether drying is complete.

In a further example, the content of the binder may be at least 0.1 wt %, such as at least 0.2 wt %, or at least 0.3% for the weight of the dried feedstock. In another example, the binder content may be up to 30 wt %, such as at most 25%, at most 20%, at most 15%, at most 10%, at most 5%, at most 4 wt %, at most 3 wt %, at most 2 wt %, or at most 1 wt % for the weight of the dried feedstock. Moreover, the content of the binder may be in a range including any of the minimum and maximum percentages noted herein.

In an embodiment, the method 100 may include forming a gel from the mixture of the feedstock. In a further embodiment, the feedstock may include a particular binder that may facilitate improved formation and/or improved properties of the composition of embodiments herein. In a particular embodiment, the binder may include a group capable of forming an ionic bond with a gelling agent. For example, the binder may include a polysaccharide, such as an alginate and/or a pectin. In a more particular example, the binder may include a polysaccharide including a group capable of forming an ionic bond with a gelling agent. An example of such polysaccharide may be chosen from alginates including sodium alginates, potassium alginates, ammonium alginates, calcium alginates, and mixtures thereof, preferably among sodium alginates, potassium alginates, ammonium alginates, and mixtures thereof. A particular example of alginate may include ammonium alginate.

In an exemplary implementation, the binder, such as polysaccharide, can be provided in the form of a solution. In a particular exemplary implementation, a solution including alginate may be used.

In an embodiment, the method 100 may include contacting the binder with a gelling agent. In an example, the method 100 may include forming the mixture of a feedstock including the binder and the gelling agent. An exemplary gelling agent may include divalent cations, trivalent cations, e.g., a Fe or Al cation, or mixtures thereof. A particular example of the gelling agent may include alkaline-earth cations, such as one or more of Ca, Sr, Ba, and Mg cations. In a particular example, the binder may include a polysaccharide including a group capable of forming an ionic bond with a Ca cation.

In another embodiment, the method 100 may include forming a gelled binder. In an example, a gelled binder may include a gelled polysaccharide, e.g., gelled alginate and/or a gelled pectin. In another embodiment, the method 100 may include forming a gelled feedstock. In still another embodiment, the gelled feedstock may include a particular content of a gelled binder that may facilitate improved formation and/or improved properties of the composition. In a particular example, the gelled binder may include gelled polysaccharide. In another example, the gelled polysaccharide may be in a content of at least 0.1 wt % for the total weight of the anhydrous gel of the feedstock, such as at least 0.2 wt %, or at least 0.3% of the total weight of the anhydrous gel of the feedstock. In still another example, the anhydrous gel of the feedstock may include at most 5% of the gelled polysaccharide, such as at most 4 wt %, at most 3 wt %, at most 2 wt %, or at most 1 wt % of the gelled polysaccharide for the total weight of the anhydrous gel. Moreover, the gelled polysaccharide may be in a content including any of the minimum and maximum percentages noted herein. The gelled feedstock may be dried in the manner discussed in embodiments herein.

The feedstock may optionally further include a solvent and/or a plasticizer and/or a lubricant, the natures and quantities of which may be adapted to the shaping method.

A particular example of the solvent may include water. The amount of solvent may be adapted to the shaping method as well as to the presence of the binder, e.g., polysaccharide having a group capable of forming an ionic bond with a gelling agent in the feedstock.

In an embodiment, part of the solvent may be removed prior to shaping when the amount of the solvent is too large compared with the shaping method. One or more known techniques may be used to remove at least part of the solvent. For example, drying may be used. Drying may be performed as discussed in embodiments herein. For example, the feedstock may be dried in air or vacuum. The drying temperature may be controlled such that the maximum temperature reached during drying may be greater than 20° C., and up to 200° C.

In an embodiment, the feedstock may include a particular content of a plasticizer that may facilitate improved formation of the product. For example, the plasticizer content may be in a range of 0.1% to 10%, in a range of 0.5% to 5%, or in a range of 0.5% to 2%, by weight based on the weight of the dried paste.

Plasticizers conventionally used for the manufacture of porous ceramic products may be used, for example polyethylene glycol, polyolefin oxides, hydrogenated oils, alcohols, in particular glycerol and glycol, esters, and mixtures thereof. In a particular embodiment, the feedstock may not include a plasticizer.

In an embodiment, the feedstock may include a lubricant. For example, the lubricant content may be in a range from 0.1% to 10%, in a range from 0.5% to 5%, or in a range from 0.5% to 2%, by weight based on the weight of the dried paste.

Lubricants conventionally used for the manufacture of porous ceramic products can be used, for example petroleum jelly and/or glycerin and/or waxes.

After reading this disclosure, a skilled artisan will appreciate that the presence and nature of the lubricant and/or plasticizer may depend on the shaping technique used.

In a particular embodiment, the feedstock may not include lubricants.

In another particular embodiment, the feedstock may consist essentially of the washed paste, the binder, and a solvent.

Mixing of the constituents of the feedstock can be carried out according to any technique known to the person skilled in the art, for example in a mixer. In a particular example, mixing may be conducted in a high intensity mixer, in a Z-arm mixer, in turbulate, or in a jar mill with balls, such as alumina beads. In a more particular example, mixing may be carried out in a high intensity mixer.

In a further embodiment, the total mixing time for preparing the feedstock may be greater than 5 minutes, and less than 120 minutes, or less than 60 minutes.

In an embodiment, the feedstock may be shaped to obtain a preform. In a further embodiment, the preform may be brought into contact with a solution including a gelling agent capable of gelling the binder. The gelling agent may be chosen from divalent cations, trivalent cations, and mixtures thereof. The solution containing the gelling agent may be selected from a solution including a divalent cation salt, a solution including a trivalent cation salt, or a mixture thereof. A particular example of the solution may include brine, from which certain ion extractions may be performed with the product. In another particular example, the solution may include an iodide solution including a divalent cation salt or a trivalent cation salt.

In a particular example, the gelling agent may be chosen from alkaline-earth cations, such as Ca, Sr, Ba, and/or Mg cations and mixtures thereof. In a more particular example, the gelling agent may be a Ca cation. In another example, the gelling solution may include a solution comprising an alkaline-earth cation iodide and/or an alkaline-earth cation chloride. In a particular example, the gelling solution may be a solution comprising an alkaline-earth cation chloride, or more particularly, a solution comprising calcium chloride.

In a particular implementation, the gelling solution may be the source of lithium from which the lithium may be extracted, such as brine comprising a divalent and/or trivalent cation from which lithium may be collected.

In another example, the gelling solution may be a calcium chloride solution, wherein the calcium chloride concentration may be greater than 1 mol/l, or greater than 2 mol/l of the solution.

In a further embodiment, contacting the preform with the gelling solution may be performed, for example, by immersing the preform in a bath of the gelling solution or by spraying the preform with the gelling solution.

In one embodiment, the shaping and contacting the preform with the gelling solution may be coincident. In a particular example, drop-by-drop gelling may be performed.

It is to be appreciated that the feedstock may be shaped into any suitable shape. For instance, a suitable shape may include cylinders, polylobes, rings, sheets, or spheres. It can be appreciated that dimensions of the shape may be formed as desired by applications. In certain examples, a suitable shape may include a larger dimension of at most 100 mm, such as at most 80 mm, at most 50 mm, at most 30 mm, at most 10 mm, at most 5 mm, at most 3 mm, or at most 2 mm. In another instance, the shape may include a smaller dimension that may be measured in a plane perpendicular to the direction of the largest dimension, wherein the smaller dimension may be at least 1 μm, at least 10 μm, at least 30 μm, at least 50 μm, at least 80 μm, at least 100 μm, at least 300 μm, at least 450 μm, at least 650 μm, or at least 800 μm.

In another example, the feedstock may be formed into the shape of a coating. In an example, the coating may a thickness of at least 10 μm, such as at least 50 μm, at least 100 μm, at least 200 μm, or at least 1 mm. In another example, the thickness may be at most 500 μm. Moreover, the thickness may be in a range including any of the minimum and maximum values noted herein. In a further example, the coating may be disposed over a substrate. An exemplary substrate may be made of a material chosen from ceramics, metals, organic products, in particular polymers, and mixtures thereof. It is to be appreciated that the thickness of the coating may be formed as desired by applications.

In another embodiment, the method 100 may optionally include reducing the water content from the shaped feedstock. In a further embodiment, shaping and water reduction may be performed at least partially simultaneously. In an embodiment, drying may be used to reduce the water content. In an example, the maximum temperature of the gel may be greater than 20° C. and less than 200° C. or at most 100° C. In a further example, the drying cycle may include a plateau at the maximum drying temperature. The holding time at the plateau may be greater than 5 seconds and less than 20 hours. In another example, drying may be carried out in air at atmospheric pressure or under vacuum.

In a further embodiment, the water content after drying may be greater than 5%, preferably greater than 10% and preferably less than 60%, based on the mass of the dried composition.

In an embodiment, as illustrated in block 108 of FIG. 1, the composition of embodiments herein may be obtained after shaping and optionally drying.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

### EMBODIMENTS

Embodiment 1. A composition, comprising:
a crystalline phase including lithiated bayerite; and
a total content of aluminum hydroxide and boehmite of not greater than 10 wt % for a total weight of the composition,
wherein the composition has a Li/B Selectivity Factor of at least 4.2 and a Turbidity Factor of less than 1000 NTU.

Embodiment 2. The composition of embodiment 1, comprising:
a content of Li of greater than 2 wt % and less than 5 wt % for a dry weight of the composition;
a content of Cl of greater than 10 wt % and less than 26% for the dry weight of the composition; and
a content of Al of greater than 15 wt % and less than 30 wt % for the dry weight of the composition.

Embodiment 3. The composition of embodiment 1 or 2, comprising the Li/B Selectivity Factor of at least 4.2, at least 4.5, at least 4.7, at least 5.1, at least 5.6, at least 6.1, at least 6.5, at least 6.9, at least 7.5, at least 7.9, at least 8.4, at least 8.9, at least 9.3, at least 9.7, at least 10.3, at least 10.6, at least 11.2, at least 11.6, at least 12.2, at least 12.6, at least 13.2, at least 13.8, or at least; and/or wherein the composition comprises the Li/B Selectivity Factor of at most 32.5, at most 27.5, at most 25.5, at most 22.5, at most 21.0, at most 19.6, or at most 17.5.

Embodiment 4. The composition of any one of embodiments 1 to 3, comprising a Turbidity Factor of less than 1000 NTU, less than 980 NTU, at most 850 NTU, at most 700 NTU, at most 600 NTU, at most 500 NTU, at most 400 NTU, at most 300 NTU, at most 210 NTU, at most 180 NTU, at most 160 NTU, at most 130 NTU, at most 110 NTU, at most 90 NTU, at most 80 NTU, or at most 75 NTU; and/or wherein the composition comprises a Turbidity Factor of at least 1 NTU, at least 5 NTU, at least 10 NTU, at least 15 NTU, at least 25 NTU, at least 40 NTU, at least 50 NTU, at least 60 NTU, at least 80 NTU, at least 100 NTU, or at least 130 NTU.

Embodiment 5. The composition of any one of embodiments 1 to 3, comprising water.

Embodiment 6. The composition of any one of embodiments 1 to 3, comprising a content of water of at most 85 wt %, at most 75 wt %, at most 65 wt %, or at most 55 wt % for the total weight of the composition; and/or wherein the content of water is at least 10 wt %, at least 25 wt %, at least 40 wt %, at least 50 wt %, or at least 55 wt % for the total weight of the composition.

Embodiment 7. The composition of any one of embodiments 1 to 3, comprising a crystalline phase comprising lithiated bayerite crystallites, wherein the crystalline phase further comprises boehmite, aluminum hydroxide, or any combination thereof, wherein the aluminum hydroxide comprises gibbsite, bayerite, doyleite, nordstrandite, or any combinations thereof.

Embodiment 8. The composition of any one of embodiments 1 to 3, wherein the crystalline phase further comprises aluminum hydroxide including gibbsite, bayerite, doyleite, nordstrandite, or any combinations thereof.

Embodiment 9. The composition of any one of embodiments 1 to 3, wherein a majority or essentially all of the crystalline phase comprises lithiated bayerite crystallites.

Embodiment 10. The composition of any one of embodiments 1 to 3, wherein at least 80 wt % of the composition comprises water, lithiated bayerite, aluminum hydroxide and/or boehmite, LiCl, and a binder.

Embodiment 11. The composition of any one of embodiments 1 to 3, wherein at least 90 wt % of the composition comprises water, lithiated bayerite, aluminum hydroxide, LiCl, and a binder.

Embodiment 12. The composition of any one of embodiments 1 to 3, wherein at least 90 wt %, at least 95 wt %, or at least 98 wt % of the composition comprises water, lithiated bayerite, LiCl, and a binder; and/or wherein the composition consist essentially of water, lithiated bayerite, LiCl, and a binder; and/or wherein the composition comprises a total content of impurities of at most 3 wt %, at most 2 wt %, at most 1 wt %, or less than 1 wt % of the composition, wherein the impurities comprise sodium chloride, sodium hydroxide, ammonium hydroxide, aluminum chloride, or any combination thereof.

Embodiment 13. The composition of any one of embodiments 1 to 3, comprising a binder comprising a polysaccharide.

Embodiment 14. A device, comprising the composition of any one of embodiments 1 to 3, wherein the device is configured to collect lithium from a solution via the composition.

Embodiment 15. An ion adsorption column, comprising the composition of any one of embodiments 1 to 3, wherein the ion adsorption column is configured to extract lithium from a brine via the composition.

Embodiment 16. A method, comprising:
forming a mixture including lithiated bayerite;
changing a pH of the mixture to less than 7;
washing the mixture with an aqueous phase; and
forming a composition comprising a crystalline phase comprising lithiated bayerite.

Embodiment 17. The method of embodiment 16, further comprising dissociating agglomerated particles present in the mixture prior to adding the acid.

Embodiment 18. The method of embodiment 17, wherein dissociating is performed via high shear mixing.

Embodiment 19. The method of any one of embodiments 16 to 18, comprising adding an acid to change the pH of the mixture to at most 6.0, at most 5.5, at most 5.0, at most 4.5, at most 4.0, at most 3.5, at most 3.0, below 3.0, at most 2.5, at most 2.0, at most 1.5, or at most 1.0; and/or wherein the pH is changed to a range of up to 6.0, or a range from 1.0 to 6.0 or a range from 1.0 to below 3.0.

Embodiment 20. The method of any one of embodiments 16 to 19, wherein the aqueous phase comprises water.

Embodiment 21. The method of any one of embodiments 16 to 19, wherein a weight ratio of the aqueous phase to the mixture is less than 1:1, at most 0.9:1, at most 0.8:1, at most 0.7:1, or at least 0.6:1; and/or the weight ratio of the aqueous solution to the mixture is at least 0.4:1, at least 0.5:1, at least 0.6:1, at least 0.7:1, or at least 0.8:1.

Embodiment 22. The method of any one of embodiments 16 to 19, comprising reusing the aqueous phase after washing in forming the mixture including lithiated bayerite.

Embodiment 23. The method of any one of embodiments 16 to 19, wherein forming the mixture comprises mixing a source of aluminum and a chloride salt including Li, wherein a molar ratio of Cl to Al is greater than 0.25, and a molar ratio of Li to Al is at least 1, and wherein the source of aluminum comprises boehmite, aluminum hydroxide, or a mixture thereof.

Embodiment 24. The method of embodiment 23, wherein the chlorine salt including Li comprises the aqueous solution recovered after washing.

Embodiment 25. The method of any one of embodiments 16 to 19, wherein the composition is configured to selectively collect lithium over boron.

Embodiment 26. The method of any one of embodiments 17 to 25, wherein the agglomerated particles comprise aluminum hydroxide.

### Example 1

Samples CS1, CS2, S3-S6, and S13 are made using the raw materials including gibbsite Al(OH)₃ powder, having a median size equal to 0.3 μm, of purity greater than 99.5% by mass; Lithium hydroxide monohydrate (LiOH H₂O), of purity greater than 99.5% by mass; Lithium chloride LiCl, of purity greater than 99.5% by mass, Hydrochloric acid HCl, of purity greater than 99% by mass, in 16M aqueous solution; and ammonium alginate of purity greater than 99% by mass and the following steps.

In step a), for each example, 15 Kg of aluminum hydroxide are added to 72.6 l of water, at a temperature equal to 25° C., in a stirred double jacketed reactor.

In step b), for each example, (LiOH H₂O) is added to the mixture obtained at the end of step a). The amounts of (LiOH H₂O) and the molar ratio between the OH supplied by (LiOH H₂O) and the Al initially present in the mixture is as described in Table 1. For each example, the temperature at which step b) took place, the mixing time, and the pH of the mixture measured at the end of step b) are also described in Table 1.

In step c), for each example, LiCl is added to the mixture obtained at the end of step b), so that the molar ratio between the Cl supplied by LiCl and the Al initially present in the mixture is as described in Table 1. For each example, the temperature at which this step took place and the mixing time are described in Table 1.

At the end of step c), the amount of lithium in the mixture, expressed as the Li/Al molar ratio, is as described in Table 1.

In step d), high shear mixing for deagglomeration is performed for forming Samples S3-S6, using an inline dispersing machine IKA Turrax UTL 2000, for the time indicated at Table 1.

In step e), the mixture is heated by means of a thermostat connected to the water jacket of the reactor, to a temperature T₁, the time t₁ being the time during which said mixture is at a temperature greater than or equal to 50° C. Table 1 describes for each example the temperature T₁ and the time t₁.

In step f), for each example, the mixture is maintained at a constant temperature T₂₁ for a time t₂ as noted in Table 1.

In step g), for each sample, HCl is added to the mixture obtained at the end of step f), so that the pH of the mixture is lowered to the value indicated in Table 1. The Cl/Al molar ratio value in the mixture after the addition of HCl is as described in Table 1, the acid being introduced at a temperature equal to T₃₁ that is kept constant during step g), the time t₃ being the time during which the mixture is at a temperature greater than or equal to 50° C. T₃₁ and t₃ are described in Table 1.

In step h), for each example, the mixture is filtered through a M.W Watermark filter press unit, at ambient temperature (less than 50° C.), with filters having a permeability of 2 l/(m²·s) (ISO 9237), and a paste is obtained after filtration. The time t₄ during which the mixture is at a temperature greater than or equal to 50° C. is described in Table 1.

In step i), washing is performed after filtration for forming Samples S3 to S6 and S13. The weight ratio of the liquid phase to paste, the liquid phase, and the washing time t₅ are included in Table 1.

Table 1 below summarizes the parameters used in the manufacturing steps.

TABLE 1

| Samples | CS1 | | CS2 | | S13 | | S3 | | S4 | | S5 | | S6 | |
|---|---|---|---|---|---|---|---|---|---|---|---|---|---|---|
| Step b), amount of | 4.03 | | 4.03 | | 4.03 | | 4.03 | | 4.03 | | 4.03 | | 4.03 | |
| LiOH, H₂O added, in | | | | | | | | | | | | | | |
| kg | | | | | | | | | | | | | | |
| Step b), OH/Al molar | 0.5 | | 0.5 | | 0.5 | | 0.5 | | 0.5 | | 0.5 | | 0.5 | |
| ratio | | | | | | | | | | | | | | |
| Temperature at which | 25° | C. | 25° | C. | 25° | C. | 25° | C. | 25° | C. | 25° | C. | 25° | C. |
| step b) took place | | | | | | | | | | | | | | |
| Step b), mixing time | 15 | min | 15 | min | 15 | min | 15 | min | 15 | min | 15 | min | 15 | min |
| Step c), Cl/Al molar | 1 | | 1 | | 1 | | 1 | | 1 | | 1 | | 1 | |
| ratio | | | | | | | | | | | | | | |
| Temperature at which | 25° | C. | 25° | C. | 25° | C. | 25° | C. | 25° | C. | 25° | C. | 25° | C. |
| step c) took place | | | | | | | | | | | | | | |
| Step c), mixing time | 15 | min | 15 | min | 15 | min | 15 | min | 15 | min | 15 | min | 15 | min |
| Li/Al molar ratio in | 1.5 | | 1.5 | | 1.5 | | 1.5 | | 1.5 | | 1.5 | | 1.5 | |
| the mixture at the end | | | | | | | | | | | | | | |
| of step c) | | | | | | | | | | | | | | |
| Step d), Deagglomeration | 0 | min | 0 | min | 15 | min | 15 | min | 15 | min | 15 | min | 15 | min |
| time | | | | | | | | | | | | | | |
| Step e), temperature | 60° | C. | 60° | C. | 60° | C. | 60° | C. | 60° | C. | 60° | C. | 60° | C. |
| T₁ | | | | | | | | | | | | | | |
| Step e), time t₁ | 15 | min | 15 | min | 15 | min | 15 | min | 15 | min | 15 | min | 15 | min |
| Step f), temperature | 60° | C. | 60° | C. | 60° | C. | 60° | C. | 60° | C. | 60° | C. | 60° | C. |
| T₂₁ | | | | | | | | | | | | | | |
| Step f), time t₂ | 20 | min | 20 | min | 20 | min | 20 | min | 20 | min | 20 | min | 20 | min |
| Step g), pH after | 3 | | 7 | | 3 | | 5 | | 3 | | 2 | | 1 | |
| addition of HCl | | | | | | | | | | | | | | |
| Step g), Cl/Al molar | 1.6 | | 1.6 | | 1.6 | | 1.6 | | 1.6 | | 1.6 | | 1.6 | |
| ratio after addition of | | | | | | | | | | | | | | |
| HCl | | | | | | | | | | | | | | |
| Step g), temperature | 60° | C. | 60° | C. | 60° | C. | 60° | C. | 60° | C. | 60° | C. | 60° | C. |
| T₃₁ | | | | | | | | | | | | | | |
| Step g), time t₃ | 5 | min | 5 | min | 5 | min | 5 | min | 5 | min | 5 | min | 5 | min |
| Step h), time t₄ | 5 | min | 5 | min | 5 | min | 5 | min | 5 | min | 5 | min | 5 | min |
| Step i), Washing step | — | | — | | 0.4 | | 0.8 | | 0.8 | | 0.8 | | 0.8 | |
| Liquid phase/paste | | | | | | | | | | | | | | |
| weight ratio | | | | | | | | | | | | | | |
| Step i), Washing step | / | | / | | Deionized | | Deionized | | Deionized | | Deionized | | Deionized | |
| Liquid phase | | | | | water | | water | | water | | water | | water | |
| Step i), Washing step | 0 | min | 0 | min | 5 | min | 5 | min | 5 | min | 5 | min | 5 | min |

Washing time t₅

The various pastes obtained have the characteristics shown in Table 2 below.

TABLE 2

| | CS1 | CS2 | CS3 | S3 | S4 | S5 | S6 |
|---|---|---|---|---|---|---|---|
| Quantity of water, | 55%-65% | 55%-65% | 55%-65% | 55%-65% | 55%-65% | 55%-65% | 55%-65% |
| in percentage by | | | | | | | |
| mass | | | | | | | |
| Crystallized phases | Lithiated | Lithiated | Lithiated | Lithiated | Lithiated | Lithiated | Lithiated |
| demonstrated | bayerite | bayerite | bayerite | bayerite | bayerite | bayerite | bayerite |
| Combined aluminum | Less | Less | Less | Less | Less | Less | Less |
| hydroxide and | than 10% | than 10% | than 10% | than 10% | than 10% | than 10% | than 10% |
| boehmite content (%) | | | | | | | |

Chemical analysis by inductively coupled plasma spectrometry, after drying in
air at 200° C. for 16 hours, at atmospheric pressure, in percentage by weight

| | | | | | | | |
|---|---|---|---|---|---|---|---|
| Li content (wt %) | 3.0-4.5 | 3.0-4.5 | 3.0-4.5 | 3.0-4.5 | 3.0-4.5 | 3.0-4.5 | 3.0-4.5 |
| Cl content (wt %) | 19-22 | 19-22 | 19-22 | 19-22 | 19-22 | 19-22 | 19-22 |
| Al content (wt %) | 20-21.5 | 20-21.5 | 20-21.5 | 20-21.5 | 20-21.5 | 20-21.5 | 20-21.5 |
| Content of elements | 0.1 | 0.1 | 0.1 | 0.1 | 0.1 | 0.1 | 0.1 |
| other than Li, Al, | | | | | | | |
| Cl, O and H (%) | | | | | | | |
| O and H elements (%) | Supplement | Supplement | Supplement | Supplement | Supplement | Supplement | Supplement |
| | to 100 | to 100 | to 100 | to 100 | to 100 | to 100 | to 100 |
| Quantity of water, | 55%-65% | 55%-65% | 55%-65% | 55%-65% | 55%-65% | 55%-65% | 55%-65% |
| in percentage by | | | | | | | |
| mass | | | | | | | |
| Crystallized phases | Lithiated | Lithiated | Lithiated | Lithiated | Lithiated | Lithiated | Lithiated |
| demonstrated | bayerite | bayerite | bayerite | bayerite | bayerite | bayerite | bayerite |
| Combined aluminum | Less | Less | Less | Less | Less | Less | Less |
| hydroxide and | than 10% | than 10% | than 10% | than 10% | than 10% | than 10% | than 10% |
| boehmite content (%) | | | | | | | |

Chemical analysis by inductively coupled plasma spectrometry, after drying in
air at 200° C. for 16 hours, at atmospheric pressure, in percentage by weight

| | | | | | | | |
|---|---|---|---|---|---|---|---|
| Li content (wt %) | 3.0-4.5 | 3.0-4.5 | 3.0-4.5 | 3.0-4.5 | 3.0-4.5 | 3.0-4.5 | 3.0-4.5 |
| Cl content (wt %) | 19-22 | 19-22 | 19-22 | 19-22 | 19-22 | 19-22 | 19-22 |
| Al content (wt %) | 20-21.5 | 20-21.5 | 20-21.5 | 20-21.5 | 20-21.5 | 20-21.5 | 20-21.5 |
| Content of elements | 0.1 | 0.1 | 0.1 | 0.1 | 0.1 | 0.1 | 0.1 |
| other than Li, Al, | | | | | | | |
| Cl, O and H (%) | | | | | | | |
| O and H elements (%) | Supplement | Supplement | Supplement | Supplement | Supplement | Supplement | Supplement |
| | to 100 | to 100 | to 100 | to 100 | to 100 | to 100 | to 100 |

Performance

| | | | | | | | |
|---|---|---|---|---|---|---|---|
| Turbidity Factor | >1000 NTU | >1000 NTU | >1000 NTU | 72 NTU | 90 NTU | 275 NTU | 697 NTU |
| (Attrition at 15 min) | | | | | | | |
| Li/B Selectivity | 4.1 | 3.8 | 5.7 | 5.5 | 6.3 | 12.1 | 16.0 |
| Factor | | | | | | | |

For each example, the paste obtained was then shaped in the following manner.

A feedstock consisting of the paste obtained at the end of step g) and ammonium alginate was produced, including 2 wt % of the alginate for the weight of the feedstock after drying at 200° C. for 16 hours at atmospheric pressure.

The paste and the ammonium alginate were mixed in a laboratory mill under hot air created by a heat gun set to a temperature equal to 650° C., for 100 minutes so as to obtain a homogeneous feedstock and have a water content compatible with the shaping technique. The temperature of the mixture did not exceed 100° C. as measured by IR thermometer during the entire mixing/drying process.

The starting load was then screen printed using a stainless-steel belt. The shaped adsorbent was collected and closed tightly to prevent moisture loss. Shaped adsorbents are pellets of 1.4 mm diameter and 0.9 mm height.

The shaped Samples S3 to S6 were performance tested as follows. The test results are included in Table 2.

Li/B Selectivity Factor is tested as follows.

Each of the shaped objects is introduced in a fixed bed column of 1-inch internal diameter equipped with a double jacket for temperature control. All the samples are tested at 20° C. The adsorbent is preactivated using an aqueous solution containing lithium chloride. The adsorption takes place by introducing a brine into the column. The evolution of lithium and boron concentration at the outlet of the column is analyzed during adsorption to evaluate the separation factor α_{B}^{Li} of lithium vs. boron.

$${α}_{B}^{Li} = {\int }_{0}^{V} \frac{[ \frac{( {C}_{0 - Li} - {C}_{f - Li} ) \times V}{{C}_{0 - Li} \times m} ] Li}{[ \frac{( {C}_{0 - B} - {C}_{f - B} ) \times V}{{C}_{0 - B} \times m} ] B} dV$$

C₀ is the initial concentration of the element measured at the inlet of the fixed bed that is noted with _{-Li} or _{-B} for lithium and boron, respectively; Cf is the final concentration of the element measured at the outlet of the fixed bed that is noted with _{-Li} or _{-B} for lithium and boron, respectively; V is the volume of brine; d refers to the integral, and m is the weight of the shaped object. The Separation factor is used herein as Li/B Selectivity Factor. The higher the Li/B Selectivity Factor, the better the performance.

Turbidity Factor is determined as follows.

Attrition of a shaped object in brine is evaluated by inducing a rotation of the mixture in a ball mill. The degradation of the object can be monitored because the appearance of fine particles may cause an increase of turbidity of the aqueous phase. The turbidity can be monitored by a turbidimeter by measuring the intensity of light emitted through a cell. Evolution of the turbidity after 1 hour of attrition can provide information on the mechanical strength of the shaped object. The equipment in Table 3 may be used in the test. For each sample, 50 mL of brine and 5 g of the shaped object may be used.

TABLE 3

2100N HACH turbidimeter
13 mm diameter cell from HACH
<0.1 NTU turbidity standard from HACH
20 NTU turbidity standard from HACH
200 NTU turbidity standard from HACH
1000 NTU turbidity standard from HACH
13 cm diameter jar
50 mm diameter / 70 mm height plastic pot
Ball mill (adapted for rotation of a 13 cm diameter jar at 80 rpm)
315 μm sieve

The test may be performed following the below steps. The turbidimeter can be turned on at least 30 min before running any measurements to stabilize the intensity of the emitted light. Calibration of the turbidimeter can be carried out in the range 0 to 1000 NTU using at least 4 calibration standards. 5 g of a shaped sample can be placed on a 315 μm sieve and washed with 100 mL of water to remove fine particles through the sieve. Then the sample may be soaked in 50 mL of brine in a pot having a diameter of approximately 50 mm and height of approximately 70 mm. The size of the pot can changed to suit the dimensions of the samples and the amount of brine to ensure the samples are fully soaked. Each sample can be soaked in a different pot that may be tightly fixed in ajar rotating at 80 rpm. The turbidity of the brine can be measured every 5 to 10 min. The test can be stopped after 60 min of attrition or after saturation of the turbidity (>1000 NTU). The Turbidity Factor is the turbidity at 15 min of attrition.

Evolution of turbidity with time can provide information on the attrition resistance of the sample. The lower the turbidity, the stronger the sample.

The brine used in Examples is from the South American salars which typically has a concentration of lithium from 100 to 1000 mg/L, boron of 200 to 2000 mg/L, 100-400 g/L of a total concentration of dissolved solids (TDS), pH of 3 to 8, and a temperature of 10 to 50° C. Brine from another source may be used.

Samples S3 to S6 unexpectedly demonstrate higher mechanical strength indicated by the measured Turbidity Factor and higher lithium selectivity over boron indicated by higher Li/B Selectivity Factor compared to Samples CS1 and CS2.

Sample S13 is prepared in the same manner as S4 except that during the washing step i) a liquid/solid ratio of 0.4 is used. The Turbidity Factor of Sample S13 is higher than Sample S4, suggesting a lower mechanical strength of Sample S13 compared to Sample S4. Nonetheless, Sample S13 demonstrates improved Li/B selectivity over Samples CS1 and CS2.

The foregoing embodiments represent a departure from the state-of-the-art. Embodiments are directed to a composition including a crystalline lithiated bayerite with improved extraction efficiencies of lithium ions. In particular, the composition may have improved selectivity against ions other than lithium, such as boron and other ions conventional lithium absorbents may absorb unavoidably. Improved selectivity may include reduced or minimized absorption of the other ions. The composition may have improved strength as indicated by improved Turbidity Factor. Not wishing to be bound to any theory, improved properties of the composition may be facilitated by the improved forming process, including for example, preparation of a mixture of starting materials with improved particle dispersion, carefully controlling the pH of the mixture, controlled washing and/or filtration of the mixture, or any combination thereof. It is further worth noting that improved selectivity against ions other than lithium, e.g., boron, may be independent from lithium capacity of the composition. In particular, the composition may have high lithium capacity and at the same time improved selectivity. As needed by applications, the composition may have relatively lower lithium capacity but improved selectivity against ions other than lithium may be maintained.

The specification and illustrations of the embodiments described herein are intended to provide a general understanding of the structure of the various embodiments. The specification and illustrations are not intended to serve as an exhaustive and comprehensive description of all the elements and features of apparatus and systems that use the structures or methods described herein. Separate embodiments may also be provided in combination in a single embodiment, and conversely, various features that are, for brevity, described in the context of a single embodiment, may also be provided separately or in any sub combination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A composition, comprising:
a crystalline phase including lithiated bayerite; and
a total content of aluminum hydroxide and boehmite of not greater than 10 wt % for a total weight of the composition,
wherein the composition has a Li/B Selectivity Factor of at least 4.2, and a Turbidity Factor of less than 1000 NTU.

2. The composition of claim 1, comprising:
a content of Li of greater than 2 wt % and less than 5 wt % for a dry weight of the composition;
a content of Cl of greater than 10 wt % and less than 26% for the dry weight of the composition; and
a content of Al of greater than 15 wt % and less than 30 wt % for the dry weight of the composition.

3. The composition of claim 1, comprising the Li/B Selectivity Factor of at least 5.5.

4. The composition of claim 1, comprising a Turbidity Factor of at most 700 NTU.

5. The composition of claim 1, comprising water.

6. The composition of claim 5, wherein a content of water is at least 5 wt % and at most 85 wt % for the total weight of the composition.

7. The composition of claim 1, comprising a crystalline phase comprising lithiated bayerite crystallites.

8. The composition of claim 7, wherein the crystalline phase further comprises boehmite, aluminum hydroxide, or any combination thereof.

9. The composition of claim 7, wherein the crystalline phase further comprises aluminum hydroxide including gibbsite, bayerite, doyleite, nordstrandite, or any combinations thereof.

10. The composition of claim 7, wherein a majority of the crystalline phase comprises lithiated bayerite crystallites.

11. The composition of claim 1, wherein at least 80 wt % of the composition comprises water, lithiated bayerite, LiCl, a binder, and optionally one or both of aluminum hydroxide and boehmite.

12. The composition of claim 11, wherein the binder comprises a polysaccharide.

13. A device, comprising the composition of claim 1, wherein the device is configured to collect lithium from a solution via the composition.

14. An ion adsorption column, comprising the composition of claim 1, wherein the ion adsorption column is configured to extract lithium from a brine via the composition.

15. A method, comprising:
forming a mixture including lithiated bayerite;
changing a pH of the mixture to less than 7;
washing the mixture with an aqueous phase; and
forming a composition comprising a crystalline phase comprising lithiated bayerite.

16. The method of claim 15, further comprising dissociating agglomerated particles present in the mixture prior to adding the acid.

17. The method of claim 15, wherein changing the pH of the mixture comprises adding an acid to change the pH of the mixture to at most 5.5.

18. The method of claim 15, wherein washing the mixture comprises a weight ratio of the aqueous phase to the mixture of greater than 0.4:1.

19. The method of claim 15, wherein the aqueous phase comprises water.

20. The method of claim 15, comprising reusing the aqueous phase after washing in forming the mixture including lithiated bayerite.
